(19) United States
(12) Patent Application Publication
(10) Pub. No.: US 2002/0029480 A1
(43) Pub. Date: Mar. 14, 2002

(54) Blade replacing device for a knife

(76) Inventor: Hsing Tai Lin, Taichung (TW)

Correspondence Address: Hsing Tai LIN, P.O. Box 63-99, Taichung, 406, TW

(21) Appl. No.: 09/991,758

(22) Filed: Nov. 26, 2001

Related U.S. Application Data
(63) Continuation of application No. 09/473,266, filed on Dec. 24, 1999.

(51) Int. Cl. B26B 1/08

(52) U.S. Cl. 30/125; 30/162; 30/335

(57) ABSTRACT

A knife includes a blade holder slidably received in a housing for holding a blade with one or more spring-biased protrusions. The housing has a passage for slidably receiving one or more spare blades. One or more springs are received in the housing and engaged with the spare blades for forcing the spare blades toward of the blade holder when the blade is removed from the blade holder. The blades may thus be exchanged without disassembling the housing. A button is slidably received in the housing and has one or more legs for disengaging the protrusions from the blades.

The present invention is a continuation application of U.S. patent application Ser. No. 09/473,266, filed Dec. 24, 1999, to be abandoned.

### BACKGROUND OF THE INVENTION

1. Field of the Invention

The present invention relates to a knife, and more particularly to a knife having a blade replacing device.

2. Description of the Prior Art

Typical knives comprise a blade slidably received in a housing or a handle. The blades may not be disengaged from the housing and may not be easily replaced or changed with the other blades when the old blade has been worn out. The housing has to be disassembled or the members of the housing should be separated from each other before the blades may be engaged into or disengaged from the housing.

U.S. Pat. No. 2,131,358 to Rothschild discloses the other typical scalpels including a number of blades that may be stored in a blade clip and may be moved toward the end portion of the handle of the scalpel with a movable housing. The housing is slidably engaged in the side portion of the scalpel, but may not be easily moved relative to the handle by the users or by the operators.

The present invention has arisen to mitigate and/or obviate the afore-described disadvantages of the conventional knives.

### SUMMARY OF THE INVENTION

The primary objective of the present invention is to provide a knife having a blade replacing device for allowing the blades to be easily and quickly changed without disassembling the housing.

The other objective of the present invention is to provide a knife having a knob for easily moving the blade toward the front end of the knife with a blade holder.

In accordance with one aspect of the invention, there is provided a knife comprising a housing including a channel formed therein and including a passage formed therein and communicating with the channel of the housing, a blade holder slidably received in the channel of the housing, and including a knob secured thereto and extended outward of the housing for moving the blade holder along the channel of the housing, a first blade detachably received in the blade holder, at least one second blade slidably received in the passage of the housing, and means for forcing the second blade inward toward the blade holder when the first blade is removed from the blade holder.

The second blade includes at least one notch formed therein. A device is further provided for guiding the second blade to move along the passage of the housing, and includes at least one guide rib extended inward of the passage of the housing and engaged in the notch of the second blade for guiding the second blade to move along the passage of the housing.

The housing includes a casing provided therein for defining the passage of the housing and for slidably receiving the second blade therein.

A cover is further provided and secured to the casing, the forcing means includes at least one spring secured to the cover for forcing the second blade inward toward the blade holder when the first blade is removed from the blade holder.

A device is further provided for detachably securing the cover to the casing and includes at least one depression formed in the casing, and further includes at least one catch provided in the cover and engaged with the depression of the casing for detachably securing the cover to the casing.

The forcing means includes a pusher engaged with the second blade and further includes at least one spring engaged with the pusher for biasing the second blade toward the blade holder with the pusher.

The blade holder includes a spring limb formed therein and having the spring-biased protrusion extended from the spring limb. A device is further provided for disengaging the spring-biased protrusion from the first blade to disengage the first blade from the blade holder, and includes a button slidably received in the housing and having at least one leg extended therefrom for engaging with the spring-biased protrusion and for disengaging the spring-biased protrusion from the first blade to disengage the first blade from the blade holder.

The housing includes a plurality of cavities formed therein, the blade holder includes a spring arm having a latch for engaging with the cavities of the hosing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a knife in accordance with the present invention;

FIG. 2 is an exploded view of the knife;

FIGS. 3, 4 and 5 are partial exploded views illustrating the operation of the knife;

FIG. 6 is a partial cross sectional view taken along lines 6-6 of FIG. 1;

FIG. 7 is a partial cross sectional view taken along lines 7-7 of FIG. 1; and

FIGS. 8 and 9 are schematic views illustrating the operation of the knife.

### DETAILED DESCRIPTION OF THE PREFERRED EMBODIMENT

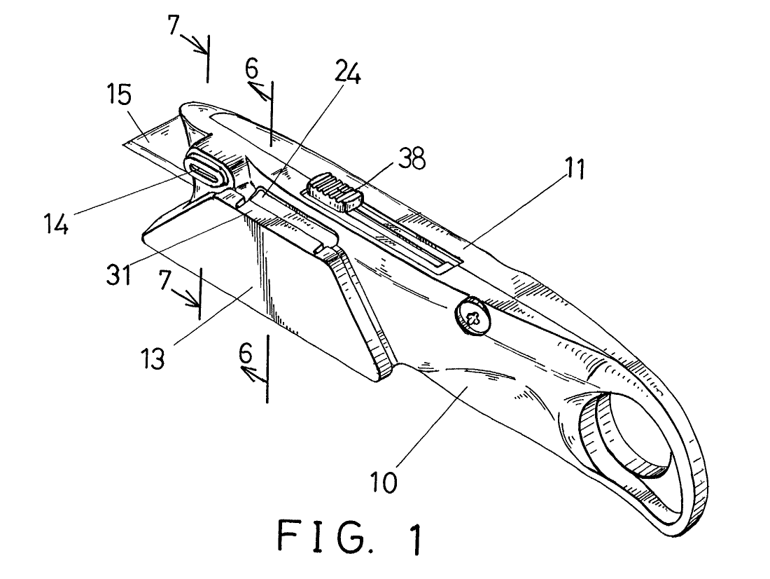

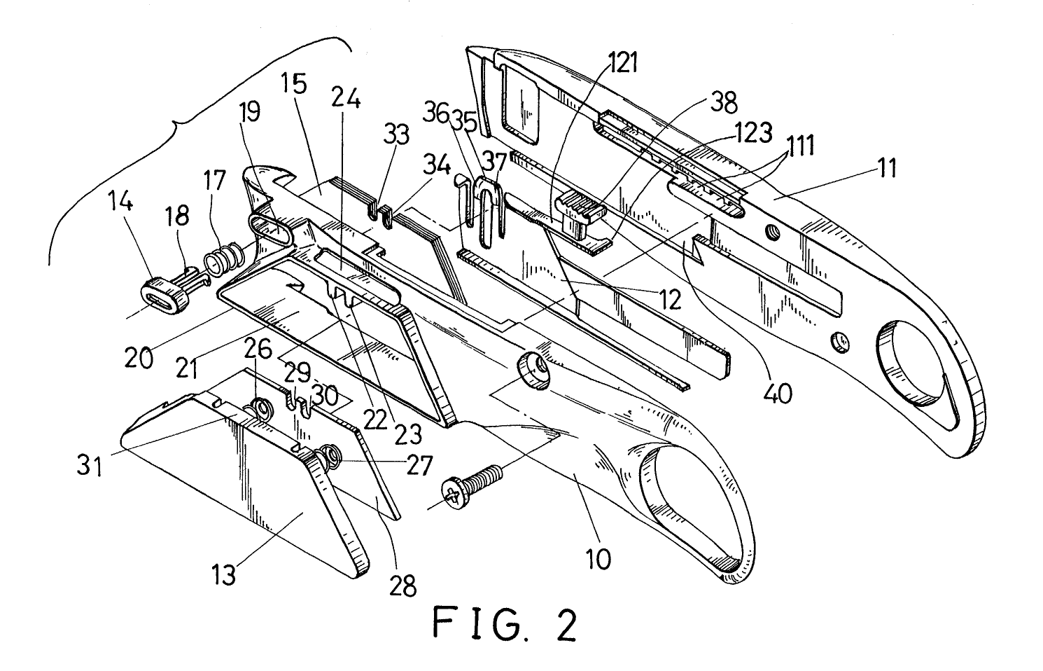

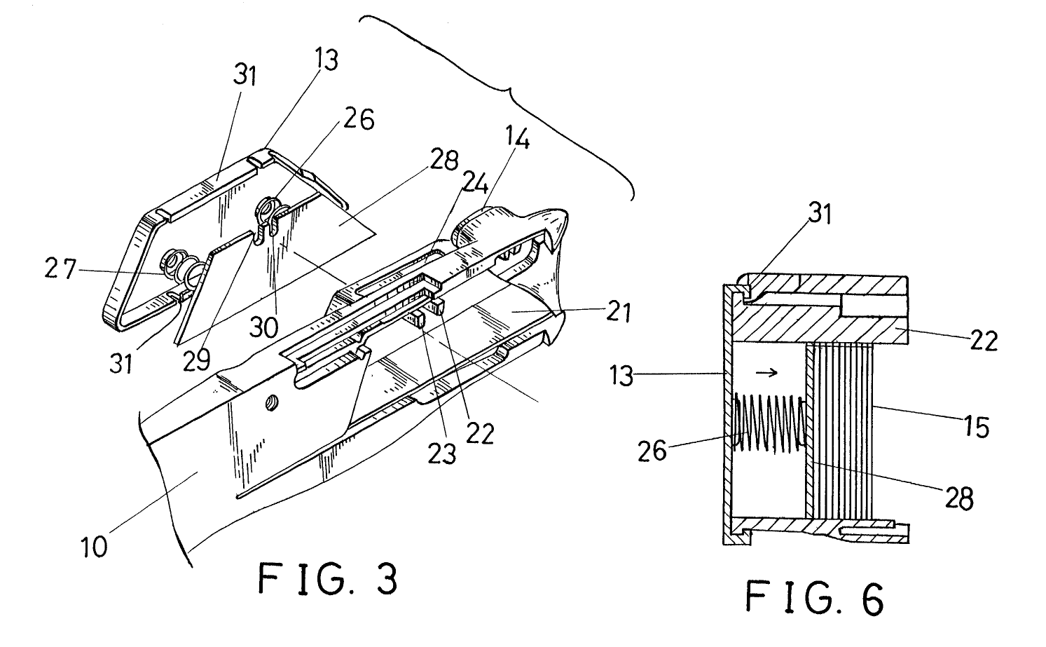

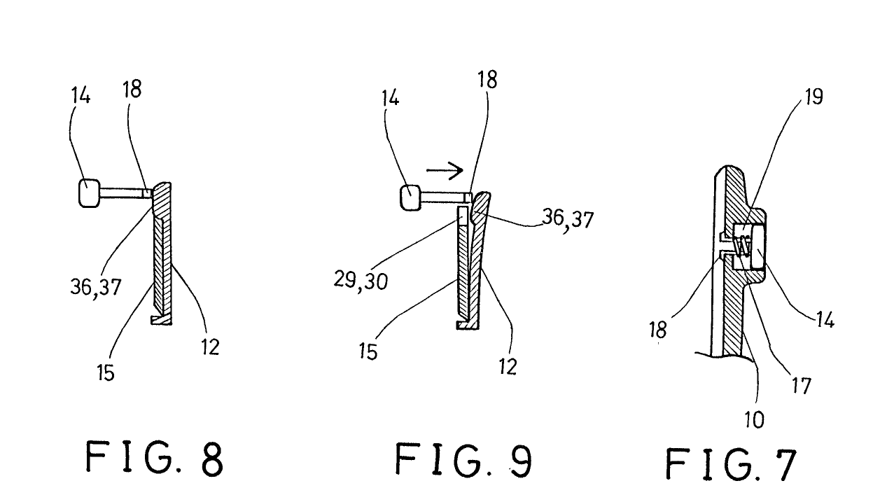

Referring to the drawings, and initially to FIGS. 1-3, a knife in accordance with the present invention comprises a handle or a housing (10, 11) including two housing members 10, 11 detachably secured together by fasteners, for example. A channel 40 is formed in either or both of the housing members 10, 11 for slidably receiving a blade holder 12 which includes a spring limb 35 formed therein and defined between a pair of parallel grooves, for example. The spring limb 35 includes one or more protrusions 36, 37 extended therefrom for engaging with one or more notches 33, 34 of a blade 15 (FIG. 4) and for securing the blade 15 to the blade holder 12. The spring limb 35 preferably includes a slot formed in the middle portion thereof for increasing the resilience of the spring limb 35 and for allowing the protrusions 36, 37 of the spring limb 35 to be easily engaged into (FIG. 8) or disengaged from the notches 33, 34 of the blade 15 (FIG. 9).

The blade holder 12 includes a spring arm 121 extended therefrom, and a knob 38 disposed on the spring arm 121 and extended outward of the housing 10, 11 (FIGS. 1, 4, 5) for allowing the blade holder 12 to be easily moved along the channel 40 of the housing 10, 11 with the knob 38. The housing 10, 11 includes one or more cavities 111 formed therein. The blade holder 12 includes a latch 123 provided therein, such as provided in the spring arm 121 for engaging with either of the cavities 111 of the housing 10, 11 and for selectively and detachably securing the blade holder 12 to the housing 10, 11. The blade 15 may be secured to the blade holder 12 with the other securing devices, but may also be loosely attached to the blade holder 12.

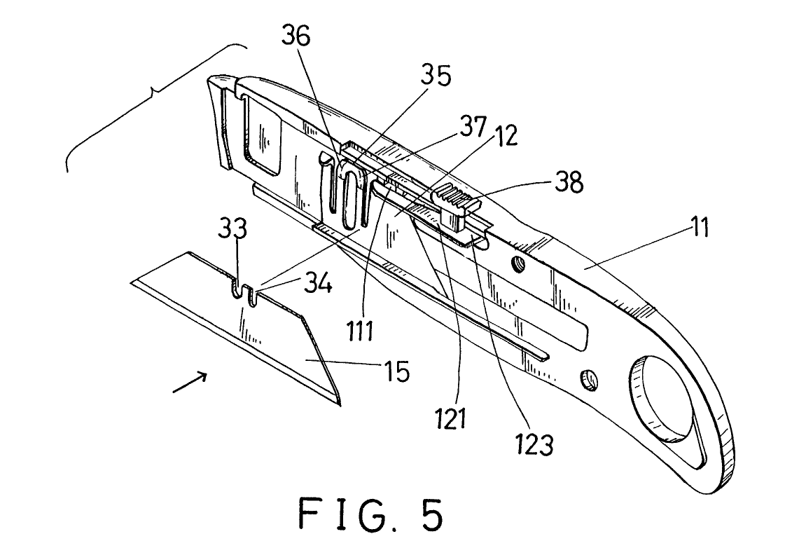

The housing member 10 of the housing 10, 11 includes an opening 19 laterally formed therein for slidably receiving a button 14 which includes a pair of spring legs 18 formed therein for engaging with the housing 10, 11 and for securing the button 14 to the housing 10, 11 (FIG. 7). A spring 17 is engaged between the button 14 and the housing 10, 11 for biasing the button 14 outward of the opening 19 of the housing 10, 11 and for disengaging the spring legs 18 of the button 14 from the protrusions 36, 37 of the spring limb 35. When the button 14 is depressed inward of the opening 19 of the housing 10, 11, the protrusions 36, 37 of the spring limb 35 may be disengaged from the notches 33, 34 of the blade 15 (FIGS. 4, 9), such that the blade 15 may be easily disengaged from the blade holder 12 without disengaging the blade holder 12 from the housing 10, 11. When the button 14 is released, the protrusions 36, 37 of the spring limb 35 may engage with the notches 33, 34 of the blade 15 again in order to secure the blade 15 to the blade holder 12 again (FIG. 8).

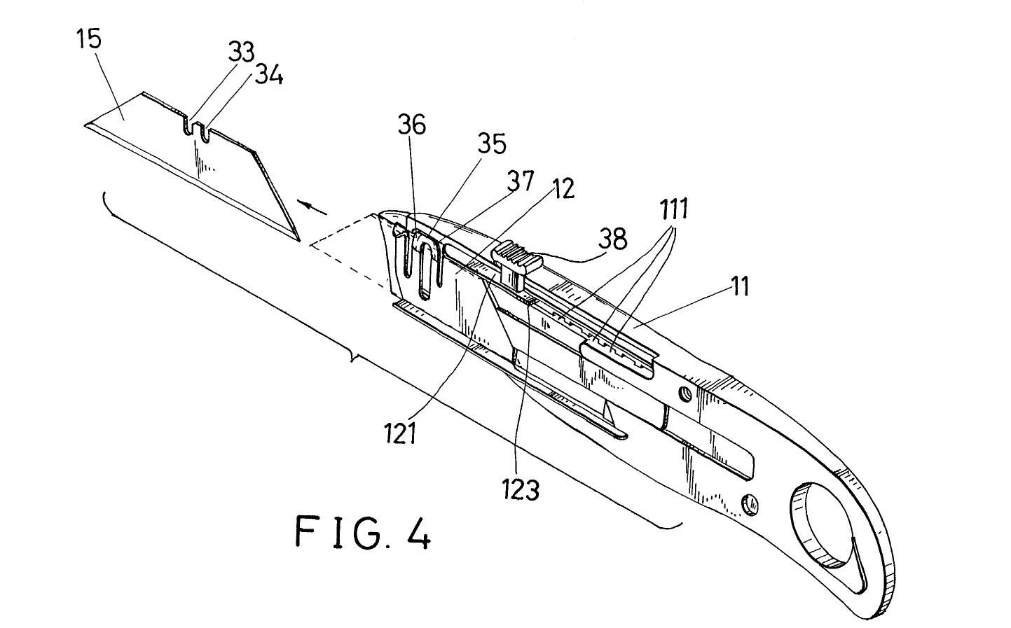

The housing member 10 includes a passage 21 formed therein and communicating with the channel 40 of the housing member 11 and preferably defined by a casing 20 for slidably receiving one or more spare blades 15 therein, and includes one or more guide ribs 22, 23 extended inward of the passage 21 and engaged into the notches 33, 34 of the blades 15 for guiding the blades 15 to move along the passage 21 of the housing 10, 11. The housing 10, 11 includes one or more depressions 24 formed therein, particularly formed in the upper portion and the lower portion thereof. A cover 13 includes one or more spring-biased catches 31 detachably engaged with the depressions 24 of the housing 10, 11 for detachably securing the cover 13 to the housing 10, 11. A pusher 28 is slidably received in the passage 21 of the housing 10, 11 and includes one or more notches 29, 30 formed therein for receiving the guide ribs 22, 23 and for allowing the pusher 28 to be guided to move along the passage 21 of the housing 10, 11. One or more springs 26, 27 are secured between the cover 13 and the pusher 28 for biasing the pusher 28 to force against the blades 15 received in the passage 21 of the housing 10, 11 (FIG. 6) and for forcing the blades 15 toward the blade holder 12. It is to be noted that, without the pusher 28, the springs 26, 27 may directly engage and bias against the blades 15.

In operation, as shown in FIGS. 4 and 9, when the protrusions 36, 37 of the spring limb 35 are disengaged from the notches 33, 34 of the blade 15 by depressing the button 14 inward of the opening 19 of the housing 10, 11, the worn out blade 15 may be easily disengaged from the blade holder 12 without disengaging the blade holder 12 from the housing 10, 11. When the worn out blade 15 is removed, the blades 15 received in the passage 21 of the housing 10, 11 (FIG. 6) may be forced toward the blade holder 12 until the protrusions 36, 37 of the spring limb 35 are engaged with the notches 33, 34 of the blade 15 that has just been moved into the blade holder 12 (FIG. 8). The blade holder 12 and thus the blade 15 may be easily and quickly moved relative to the housing 10, 11 by the knob 38 of the blade holder 12.

Accordingly, the knife in accordance with the present invention includes a blade holder for allowing the blades to be easily and quickly changed without disassembling the housing.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A knife comprising:
a housing including a channel formed therein and including a passage formed therein and communicating with said channel of said housing,
a blade holder slidably received in said channel of said housing, and including a knob secured thereto and extended outward of said housing for moving said blade holder along said channel of said housing,
a first blade detachably received in said blade holder,
at least one second blade slidably received in said passage of said housing, and
means for forcing said at least one second blade inward toward said blade holder when said first blade is removed from said blade holder.

2. The knife according to claim 1 further comprising means for guiding said at least one second blade to move along said passage of said housing.

3. The knife according to claim 2, wherein said at least one second blade includes at least one notch formed therein, said guiding means includes at least one guide rib extended inward of said passage of said housing and engaged in said at least one notch of said at least one second blade for guiding said at least one second blade to move along said passage of said housing.

4. The knife according to claim 1, wherein said housing includes a casing provided therein for defining said passage of said housing and for slidably receiving said at least one second blade therein.

5. The knife according to claim 4 further comprising a cover secured to said casing, said forcing means including at least one spring secured to said cover for forcing said at least one second blade inward toward said blade holder when said first blade is removed from said blade holder.

6. The knife according to claim 5 further comprising means for detachably securing said cover to said casing.

7. The knife according to claim 6, wherein said detachably securing means includes at least one depression formed in said casing, and further includes at least one catch provided in said cover and engaged with said at least one depression of said casing for detachably securing said cover to said casing.

8. The knife according to claim 1, wherein said forcing means includes a pusher engaged with said at least one second blade and further includes at least one spring engaged with said pusher for biasing said at least one second blade toward said blade holder with said pusher.

9. The knife according to claim 1 further comprising means for detachably securing said first and said at least one second blades to said blade holder.

10. The knife according to claim 9, wherein said first blade and said at least one second blade each includes at least one notch formed therein, said detachably securing means includes at least one spring-biased protrusion provided in said blade holder and detachably extended inward of said at least one notch of said first blade and said at least one second blade.

11. The knife according to claim 10 further comprising means for disengaging said at least one spring-biased protrusion from said first blade to disengage said first blade from said blade holder.

12. The knife according to claim 11, wherein said blade holder includes a spring limb formed therein and having said at least one spring-biased protrusion extended from said spring limb.

13. The knife according to claim 11, wherein said disengaging means includes a button slidably received in said housing and having at least one leg extended therefrom for engaging with said at least one spring-biased protrusion and for disengaging said at least one spring-biased protrusion from said first blade to disengage said first blade from said blade holder.

14. The knife according to claim 1, wherein said housing includes a plurality of cavities formed therein, said blade holder includes a spring arm having a latch for engaging with said cavities of said hosing.
